(19) United States
(12) Patent Application Publication
(10) Pub. No.: US 2025/0095057 A1
(43) Pub. Date: Mar. 20, 2025

(54) METHOD AND APPARATUS FOR PROVIDING GAME SERVICE

(71) Applicant: NEXON KOREA CORPORATION, Seongnam-si (KR)

(72) Inventors: Min Seok JANG, Seongnam-si (KR); Ki On KIM, Seongnam-si (KR)

(21) Appl. No.: 18/884,769

(22) Filed: Sep. 13, 2024

(30) Foreign Application Priority Data
Sep. 15, 2023 (KR) 10-2023-0123132
Dec. 12, 2023 (KR) 10-2023-0180095

(51) Int. Cl. G06Q 30/08

(52) U.S. Cl. CPC G06Q 30/08

(57) ABSTRACT

Provided is a method of providing a game service by a game providing apparatus. The method includes obtaining auction information associated with an auction for a game item, obtaining an auction end time range indicating a time range in which the auction ends based on the auction time information, and determining an auction end time point for the game item to be any time point within the auction end time range. In some embodiments, the auction information includes auction time information associated with a time of the auction.

### CROSS-REFERENCE TO RELATED APPLICATION

This application is based on and claims priority under 35 U.S.C. § 119 to Korean Patent Application Nos. 10-2023-0123132, filed on Sep. 15, 2023, and 10-2023-0180095, filed on Dec. 12, 2023, in the Korean Intellectual Property Office, the disclosures of which are incorporated by reference herein in their entireties.

### BACKGROUND

### Technical Field

The disclosure relates to a method and an apparatus for providing a game service. More specifically, the disclosure relates to a method and an apparatus associated with auctioning game items within a game service.

### Description of the Related Art

Recently, many games of various genres have been developed, leading to an explosive increase in the number of users playing such games. As games of various genres are developed and the performance of devices for playing games improves, gaming has emerged as a mainstream hobby.

Accordingly, the gaming industry is introducing various systems related to game items to build various game strategies using game items. For example, in-game users may use an in-game auction system to secure necessary game items.

### BRIEF SUMMARY

As the in-game auction system develops, the inventors of the present disclosure have recognized that there is a need for an improved auction system to provide equal bidding opportunities to multiple users and prevent excessive competition. The disclosure provides a method and an apparatus for providing a game service that diversifies a method of auctioning game items.

Additional aspects will be set forth in part in the description which follows and, in part, will be apparent from the description, or may be learned by practice of the presented embodiments of the disclosure.

According to an embodiment, provided is a method of providing a game service by a game providing apparatus, the method including obtaining auction information associated with an auction for a game item, wherein the auction information includes auction time information associated with a time of the auction, obtaining an auction end time range indicating a time range in which the auction ends based on the auction time information, and determining an auction end time point for the game item to be any time point within the auction end time range.

According to an embodiment, the auction time information may include at least one of an auction duration for the game item, an auction end time point for the game item, an auction start time point for the game item, and an auction end time range for the game item.

According to an embodiment, the game item may include a nickname of a character (or an in-game character).

According to an embodiment, the method may further include identifying whether a condition for registering the game item for sale is satisfied, and determining sale registration of the game item based on the identification that the condition for registering the game item for sale is satisfied.

According to an embodiment, the method may further include providing information that the auction for the game item may end at any time point when the imminent auction end time point for the game item has passed.

According to an embodiment, the method may further include providing information that the game item cannot be registered for sale based on the identification that the condition for registering the game item for sale is not satisfied.

According to an embodiment, the auction information may include at least one of a name of the game item, a type of the game item, a number of game items, a minimum bid, and a maximum bid.

According to an embodiment, the condition for registering the game item for sale may include at least one of whether the limit on the number of auctions within a certain period granted to each user is exceeded, whether the user holds goods exceeding a sale registration deposit, and whether the game item is a tradable item or an auctionable item.

According to an embodiment, the auction information may include a nickname to be used by a character after registering the nickname for sale.

According to an embodiment, the game item may be searchable by using at least one of a language, a number of characters, and a sale price range.

According to an embodiment, the method may further include providing information about the remaining time of the auction for the game item when the imminent auction end time point for the game item has not passed.

According to an embodiment, provided is a game providing apparatus including memory configured to store instructions, and at least one processor functionally connected to the memory and configured to execute the instructions. The at least one processor may execute the instructions to obtain auction information associated with the auction for the game item, wherein the auction information comprises auction time information associated with a time of the auction, obtain an auction end time range indicating a time range in which the auction ends based on the auction time information, and determine an auction end time point for the game item to be any time point within the auction end time range.

According to an embodiment, the auction time information may include at least one of an auction duration for the game item, an auction end time point for the game item, an auction start time point for the game item, and an auction end time range for the game item.

According to an embodiment, the game item may include a nickname of a character (or an in-game character).

According to an embodiment, the at least one processor may execute the instructions to identify whether a condition for registering the game item for sale is satisfied, and determine the sale registration of the game item based on the identification that the condition for registering the game item for sale is satisfied.

According to an embodiment, the at least one processor may execute the instructions to provide information that the auction for the game item may end at any time point when the imminent auction end time point for the game item has passed.

According to an embodiment, the at least one processor may execute the instructions to provide information that the game item cannot be registered for sale based on the identification that the condition for registering the game item for sale is not satisfied.

According to an embodiment, the auction information may include at least one of a name of the game item, a type of the game item, a number of game items, a minimum bid, and a maximum bid.

According to an embodiment, the condition for registering the game item for sale may include at least one of whether the limit on the number of auctions within a certain period granted to each user is exceeded, whether the user holds goods exceeding a sale registration deposit, and whether the game item is a tradable item or an auctionable item.

According to an embodiment, the auction information may include a nickname to be used by a character after registering the nickname for sale.

According to an embodiment, the game item may be searchable by using at least one of a language, a number of characters, and a sale price range.

According to an embodiment, the at least one processor may execute the instructions to provide information about the remaining time of the auction for the game item when the imminent auction end time point for the game item has not passed.

According to an embodiment, provided is a server including memory configured to store instructions, and at least one processor functionally connected to the memory and configured to execute the instructions. The at least one processor may execute the instructions to obtain auction information associated with the auction for the game item, wherein the auction information comprises auction time information associated with a time of the auction, obtain an auction end time range indicating a time range in which the auction ends based on the auction time information, and determine an auction end time point for the game item to be any time point within the auction end time range.

According to an embodiment, provided is a user terminal including memory configured to store instructions and at least one processor functionally connected to the memory and configured to execute the instructions. The at least one processor may execute the instructions to obtain auction information associated with the auction for the game item, wherein the auction information comprises auction time information associated with a time of the auction, obtain an auction end time range indicating a time range in which the auction ends based on the auction time information, and determine an auction end time point for the game item to be any time point within the auction end time range.

According to an embodiment, provided is a computer-readable recording medium comprising a program for executing, on a computer, a method of providing a game service by a game providing apparatus, wherein the method includes obtaining auction information associated with an auction of a game item, the auction information including auction time information associated with the time of the auction, obtaining an auction end time range indicating a time range in which the auction ends based on the auction time information, and determining an auction end time point for the game item to be any time point within the auction end time range.

### BRIEF DESCRIPTION OF THE SEVERAL VIEWS OF THE DRAWINGS

The above and other aspects, features, and advantages of certain embodiments of the disclosure will be more apparent from the following description taken in conjunction with the accompanying drawings, in which:

FIG. 1 is a diagram of a game providing system including a server and a user terminal, according to some embodiments;

FIG. 2 is a conceptual diagram of auction time information, according to an embodiment;

FIG. 3 is a flowchart of a method of providing a game service, according to an embodiment;

FIG. 4 is a diagram of a sale registration interface for registering an auction item for sale, according to an embodiment;

FIG. 5 is a diagram of an auction house interface, according to an embodiment;

FIG. 6 is a diagram of a bidding interface for bidding on an auction item, according to an embodiment;

FIG. 7 is a diagram of a rebidding interface for rebidding on an auction item, according to an embodiment;

FIG. 8 is a diagram of a filter interface for searching for an auction item, according to an embodiment;

FIG. 9 is a diagram of an auction house interface, according to an embodiment;

FIG. 10 is a diagram of an auction house interface, according to an embodiment;

FIG. 11 is a diagram of an auction house interface, according to an embodiment;

FIG. 12 is a diagram of an auction house interface, according to an embodiment;

FIG. 13 is a diagram of an auction house interface, according to an embodiment;

FIG. 14 is a diagram illustrating the detailed configuration of a game providing apparatus, according to an embodiment;

FIG. 15 is a diagram illustrating a detailed configuration of a server, according to an embodiment; and

FIG. 16 is a diagram illustrating a detailed configuration of a user terminal, according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, embodiments are described in detail with reference to the accompanying drawings. In addition, a method of configuring and using an electronic device according to an embodiment is described in detail with reference to the accompanying drawings. The same reference numbers or symbols shown in each drawing indicate parts or components that perform substantially the same function.

In the disclosure, the expression “at least one of a, b, or c” refers to “a,” “b,” “c,” “a and b,” “a and c,” “b and c,” “a, b and c,” or variations thereof.

Terms including ordinal numbers, such as first, second, etc., may be used to describe various components but the components are not limited by the terms. The terms are used only to distinguish one component from another. For example, a first component may be named a second component, and similarly, the second component may also be named the first component without departing from the scope of the disclosure. The term “and/or” includes a combination of a plurality of related items or any one item among the plurality of related items.

Terms used herein are used to describe embodiments and are not intended to limit the disclosure. Singular expressions include plural expressions unless the context clearly dictates otherwise. The terms “include” and “have” are intended to specify that there are features, numbers, steps, operations, components, parts, or combinations thereof described herein, but do not preclude the presence or addition of one or more other features, numbers, steps, operations, components, parts or combinations thereof.

Throughout the specification, when a part is said to be connected to another part, this includes not only the case of being directly connected but also the case of being electrically connected with another element interposed in between. Additionally, when a part is said to include a certain component, this means that the part further includes other components, rather than excluding other components, unless otherwise specified. In addition, the term “unit” or “module” described herein refers to a unit that processes at least one function or operation, which may be implemented in hardware or software or may be implemented in a combination of hardware and software.

To be more specific, the term “unit” or “module” may include any electrical circuitry, features, components, an assembly of electronic components or the like. That is, “unit” or “module” may include any microprocessor-based system including systems using microcontrollers, integrated circuit, chip, microchip, reduced instruction set computers (RISC), application specific integrated circuits (ASICs), field-programmable gate arrays (FPGAs), graphical processing units (GPUs), logic circuits, and any other circuit or processor capable of executing the various operations and functions described herein. The above examples are examples only, and are thus not intended to limit in any way the definition or meaning of the term “unit” or “module.”

In some embodiments, the various units/modules described herein may be included in or otherwise implemented by processing circuitry such as a microprocessor, microcontroller, or the like.

In the following disclosure, a game providing apparatus may include a game server, a user terminal, a game system including the game server and the user terminal, or an independent device.

In the following disclosure, the server controlling the user terminal may mean that the server provides output (any output from the user terminal, such as screen display, sound output, vibration output, and lamp emission) from the user terminal and data for the user terminal to perform certain operations through communication with the user terminal. The user terminal may control the output from the user terminal by using the previously stored data but is not limited thereto.

In the following disclosure, exchanging information or data with a user (or a user account) may include exchanging information or data with a device (or a user terminal) corresponding to or linked to the user (or the user account).

In the following disclosure, a user, a player, a user account, and a gamer may be used with the same meaning. The user terminal in the disclosure may refer to a user, a player, a user account, a gamer, or a device used by the same, depending on the context. In this disclosure, the user, the player, the user account, and the gamer may refer to an avatar or a character operated by the same or a device used by the same, depending on the context.

In the following disclosure, the term “game object” may refer to a virtual object existing in a game space. For example, the game object may include a user's character (e.g., an avatar), a user's item, etc., but is not limited thereto, and may refer to any object implemented within the game space, such as the background or terrain.

In the following disclosure, the term “character” or “in-game character” may refer to a certain object controlled by a user within the game.

In the following disclosure, the term “game item” may include any object, goods, and content and may refer to any digital content and cyber object that users can acquire within can acquire within the game, such as equipment worn by in-game characters, e.g., weapons, armor, accessories, clothing, and crystals, vehicles ridden by in-game characters, consumables, e.g., food and potions, experience points, and buffs.

In the following disclosure, the term “game goods” or “goods,” as currency used and accepted in the game, may refer to goods that users can acquire for a fee or free of charge. In other words, the game goods may refer to all types of goods used for transactions and purchases within the game, such as items and number of games within the game. The game goods may include paid goods and free goods. The game goods may include multiple types of goods. Additionally, the paid goods may include multiple types of goods and the free goods may also include multiple types of goods.

In the following disclosure, the term “auction information” may include any information related to determining the sale registration of the game item to be auctioned. For example, the auction information may include information previously stored in the game providing apparatus or information obtained from the user in relation to the game item but is not limited thereto.

In the following disclosure, the term “auction time information” included in the auction information may include any information related to the time of the auction for the game item. For example, the auction time information may include information previously stored in the game providing apparatus or information obtained from the user in relation to the game item but is not limited thereto.

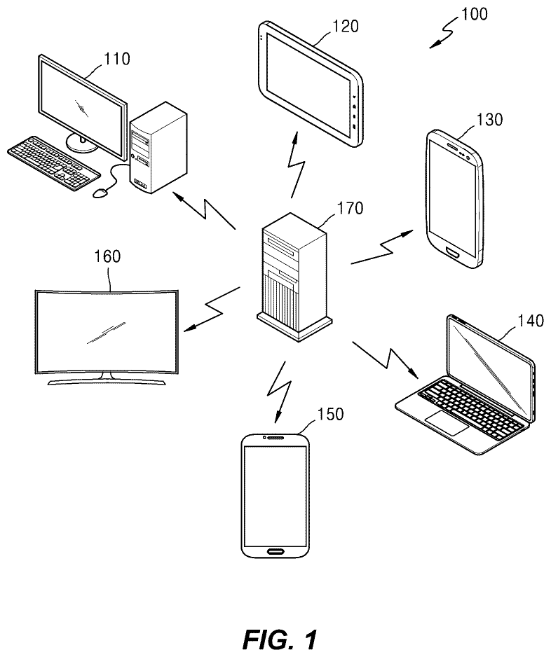

FIG. 1 is a diagram of a game providing system including a server and a user terminal, according to some embodiments.

A game providing system 100 of the disclosure may include a server 170 and at least one user terminal 110 to 160. The server 170 may provide various online activities to the at least one user terminal 110 to 160 via a network. The server 170 may provide the online activities to the at least one user terminal 110 to 160 simultaneously.

According to an embodiment, the server 170 may include a single server, an aggregate of servers, a cloud server, and the like but is not limited thereto. The server 170 may provide various online activities to the at least one user terminal 110 to 160 and may include a database storing data for the online activities of the at least one user terminal 110 to 160. The server 170 may also include a payment server that generates and processes payment events. As described above, the server 170 may include the game providing apparatus.

According to an embodiment, the network which refers to a connection established (or formed) by using any communication method may include a communication network connected through any communication method for transmitting and receiving data between terminals or between a terminal and a server.

Any communication method may include, for example, communications through a certain communication standard, a certain frequency band, a certain protocol, or a certain channel. For example, the communication method may include communications through Bluetooth, BLE, Wi-Fi, Zigbee, 3G, LTE, or ultrasound and may include a short-range communication method, a long-range communication method, a wireless communication method, and a wired communication method. However, the communication method is not limited to the above.

According to an embodiment, the short-range communication method may refer to a communication method that allows communication only when a device (e.g., a terminal or a server) performing communication is within a certain range and may include, e.g., Bluetooth, NFC, and the like. The long-range communication method may refer to a communication method that allows the device performing communication to communicate regardless of the distance. For example, the long-range communication method may refer to a method that allows two devices communicating through a repeater, such as an AP, to communicate even when the devices are separated by a certain distance or more and may include a communication method using cellular networks (3G and LTE), such as short message service (SMS) and phone calls. However, the communication method is not limited to the above. Receiving online activities using a network may mean that communication between a server and a terminal can be performed through any communication method.

Throughout the specification, the at least one user terminal 110 to 160 may include a personal computer 110, a tablet 120, a cellular phone 130, a laptop 140, a smartphone 150, and a TV 160, as well as various electronic devices, such as a personal digital assistant (PDA), a portable multimedia player (PMP), a navigation, an MP3 player, a digital camera, a refrigerator, a washing machine, and a vacuum cleaner but is not limited thereto. As described above, the at least one user terminal 110 to 160 may include the game providing apparatus.

According to an embodiment, the online activities may include, but are not limited to, an online game, a portal service, and a social network service (SNS). In addition, the online game may include various genres, such as sports, MMORPG, AOS, FPS, TCG, CCG, and the like. The online game may include a game that pit users against each other or a game that pit a user against a computer (e.g., artificial intelligence). The online game is not limited to the above and there is no limitation on the form of the online game.

According to an embodiment, the game providing apparatus may obtain auction information associated with an auction for a game item. The auction information may include auction time information associated with a time of the auction. The game providing apparatus may obtain, based on the auction time information, an auction end time range indicating a time range in which the auction ends. The game providing apparatus may determine an auction end time point for the game item to be any time point in the auction end time range.

According to an embodiment, the game providing system 100 may obtain auction information associated with the auction for the game item. The auction information may include auction time information associated with a time of the auction. The game providing system 100 may obtain, based on the auction time information, an auction end time range indicating a time range in which the auction ends. The game providing system 100 may determine the auction end time point for the game item to be any time point in the auction end time range.

According to an embodiment, the server 170 may obtain auction information associated with the auction for the game item. The auction information may include auction time information associated with a time of the auction. The server 170 may obtain, based on the auction time information, an auction end time range indicating a time range in which the auction ends. The server 170 may determine the auction end time point for the game item to be any time point in the auction end time range.

According to an embodiment, one of the at least one user terminal 110 to 160 may obtain auction information associated with the auction for the game item. The auction information may include auction time information associated with a time of the auction. One of the at least one user terminal 110 to 160 may obtain, based on the auction time information, an auction end time range indicating a time range in which the auction ends. One of the at least one user terminal 110 to 160 may determine the auction end time point for the game item to be any time point in the auction end time range.

According to an embodiment, some or all of the operations of the server 170 may be performed by the user terminal 110 to 160. For example, a method of providing a game service according to an embodiment may be performed by the user terminal 110 to 160 without communication with the server 170.

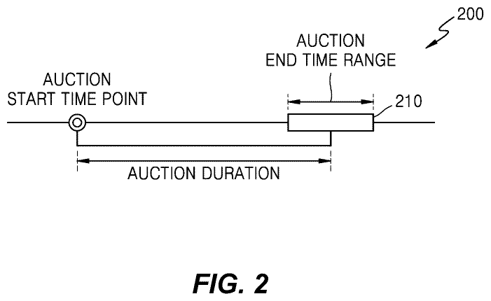

FIG. 2 is a conceptual diagram of auction time information, according to an embodiment.

In an embodiment, the game providing apparatus may obtain auction information associated with the auction for the game item. The auction information may include auction time information associated with a time of the auction.

In an embodiment, auction time information 200 may include at least one of an auction duration for the game item, an auction start time point for the game item, an auction end time range 210 for the game item, and an auction end time point for the game item.

In an embodiment, the game providing apparatus may obtain at least one piece of the auction information from user input. The game providing apparatus may obtain at least one piece of the auction time information from the user input.

In an embodiment, the game providing apparatus may obtain or determine, based on some pieces of the auction time information, the other pieces of the auction time information.

In an embodiment, the game providing apparatus may obtain or determine, based on the auction information, the auction start time point as a time point within a certain time from a time point of acquiring the auction information or a time point of determining to register the game item for sale. For example, when the game providing apparatus determines to register the game item for sale at 13:48 on November 28, the game providing apparatus may determine the auction start time point to be 14:00 on November 28.

In an embodiment, the game providing apparatus may obtain or determine, based on the auction information, an auction duration. The game providing apparatus may obtain or determine the auction duration as a preset auction duration depending on the game item or a preset auction duration in the game providing apparatus.

In an embodiment, the auction duration may represent an approximate time between the auction start time point and the auction end time point. The auction duration may include some error in the time between the auction start time point and the auction end time point. For example, when the auction start time point is 13:00 on November 24 and the auction end time point is 13:02 on November 25, the game providing apparatus may display the auction duration as 24 hours.

In an embodiment, the game providing apparatus may obtain or determine a time point at which the user input is obtained as the auction start time point. The game providing apparatus may obtain the auction duration from the user input. The game providing apparatus may determine the auction end time range 210 based on the obtained auction start time point and auction duration. The auction end time range 210 may refer to a certain range of time including a time point at which the auction duration has elapsed from the auction start time point or a time point close to the time point at which the auction duration has elapsed from the auction start time point. For example, the game providing apparatus may obtain the auction start time point of 12:00 on Nov. 24, 2023, and may obtain the auction duration as 48 hours based on the user input. The game providing apparatus may obtain a time range from 11:55 on November 26 to 12:05 on November 26 as the auction end time range 210.

In an embodiment, the game providing apparatus may obtain the auction end time point as the auction time information. The game providing apparatus may obtain or determine a certain range of time including the acquired auction end time point as the auction end time range 210. For example, when the auction end time point is obtained as 14:35 on November 24, the game providing apparatus may obtain or determine a time range from 14:30 on November 24 to 14:40 on November 24 as the auction end time range 210.

In an embodiment, the game providing apparatus may obtain the auction end time range 210 from direct user input. For example, the game providing apparatus may obtain a time range from 11:55 on November 26 to 12:05 on November 26 as the auction end time range 210.

On the other hand, the game providing apparatus may directly or indirectly obtain the auction time information and is not limited to the above.

In an embodiment, the game providing apparatus may determine the auction end time point for the game item to be any time point in the auction end time range 210. For example, when the auction end time range 210 is from 12:58 on November 25 to 13:02 on November 25, the auction end time point may include any time point between 12:58 on November 25 and 13:02 on November 25. The auction end time range 210 is not limited to the above. The game providing apparatus may determine the auction end time point to be earlier or later than a time point when the auction duration has elapsed from the auction start time point.

The auction end time point determined to be any time point in the auction end time range 210 may be different from the auction end time point included in the auction time information.

In an embodiment, the game providing apparatus may determine the auction end time point to be any time point in the auction end time range 210 to prevent sniping of the game item by bidding on the game item just before the end of the auction, thereby alleviating the load on the server. In addition, the game providing apparatus may encourage users to bid on the game item at an appropriate price with sufficient time before the end of bidding by determining the auction end time point to be any time point in the auction end time range 210.

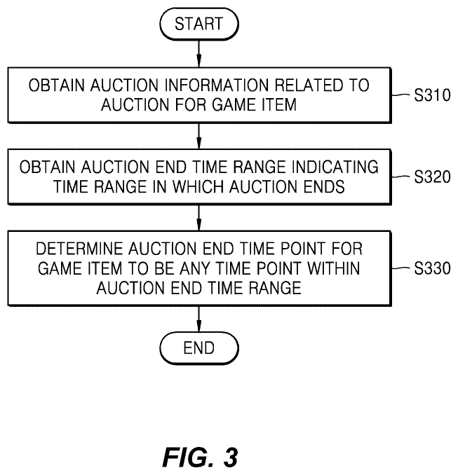

FIG. 3 is a flowchart of a method of providing a game service, according to an embodiment.

In operation S310, the game providing apparatus may obtain auction information associated with the auction for the game item.

In an embodiment, the game providing apparatus may obtain the auction information associated with the auction for the game item, wherein the auction information may include auction time information associated with a time of the auction.

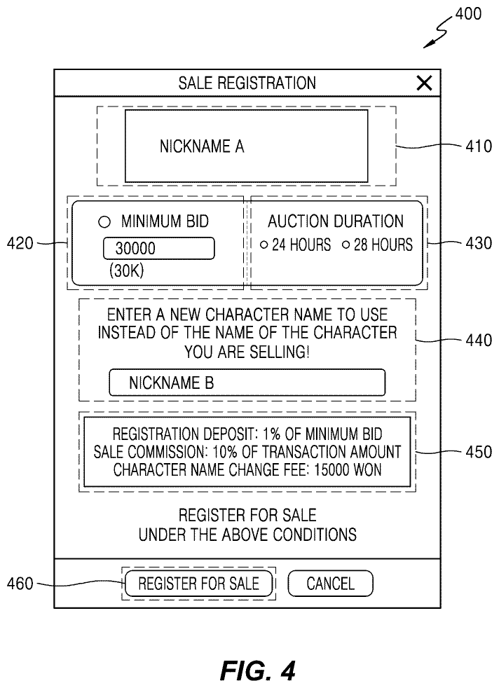

In an embodiment, the game providing apparatus may obtain, from user input, the auction information associated with the auction for the game item or the auction time information associated with the time of the auction. The game providing apparatus may obtain the auction information or the auction time information based on previously obtained information. The game providing apparatus may obtain the auction information or the auction time information based on an identified sale registration request. For example, the sale registration request may include user input to a sale registration interface for registering the game item for sale. The user input may include a touch input, a voice input, a gesture input, and the like, but is not limited thereto. The sale registration interface may be described in detail with reference to FIG. 4.

In an embodiment, the game item to be auctioned may include any object, goods, and content that can be exchanged in the game and may include a nickname of a character in the game. However, the game item to be auctioned is not limited to the above.

In an embodiment, the auction information may include at least one of a name of the game item, a type of the game item, a number of game items, a minimum bid, and a maximum bid. When the game item is a nickname of the character, the auction information may include a nickname to be used by the character after the nickname is registered for sale. Additionally, when the game item is a nickname of the character, the name of the game item may correspond to the nickname of the character. For example, when the nickname of the character is “Nickname A,” the name of the game item may be “Nickname A.”

In an embodiment, the auction time information may include at least one of an auction duration for the game item, an auction start time point for the game item, an auction end time range for the game item, and an auction end time point for the game item.

The auction information and the auction time information may be directly or indirectly obtained but are not limited thereto. Additionally, overlapping description with reference to FIG. 2 is omitted.

In operation S320, the game providing apparatus may obtain, based on the auction time information, an auction end time range indicating a time range in which the auction ends.

In an embodiment, the game providing apparatus may directly obtain, based on the auction time information, the auction end time range indicating a time range in which the auction ends. For example, the game providing apparatus may obtain the auction end time range from the user input.

In an embodiment, the game providing apparatus may indirectly obtain, based on the auction time information, the auction end time range indicating a time range in which the auction ends. The game providing apparatus may obtain or determine, based on the auction start time point and the auction duration included in the auction time information, the auction end time range. The game providing apparatus may determine, as the auction end time range, a time range within a certain range including a time point at which the auction duration has elapsed from the auction start time point or including a time point close to the time point at which the auction duration has elapsed from the auction start time point.

In an embodiment, the game providing apparatus may obtain the auction end time range by using a preset method. The game providing apparatus may obtain or determine the auction end time range based on the length of the auction end time range and the obtained auction information. For example, when the length of the auction end time range is 4 minutes, the game providing apparatus may obtain or determine, as the auction end time range, a time range from 2 minutes before to 2 minutes after the auction end time point included in the auction time information. The length of the auction end time range may be preset or obtained based on the auction information.

The method of determining the auction end time range is not limited to the above.

The auction end time range may be obtained directly or indirectly but is not limited thereto. Additionally, overlapping description with reference to FIG. 2 is omitted.

In operation S330, the game providing apparatus may determine the auction end time point for the game item to be any time point in the auction end time range.

In an embodiment, the game providing apparatus may determine the auction end time point for the game item to be any time point in the auction end time range. The auction end time point determined to be any time point in the auction end time range may be different from the auction end time point included in the auction time information.

In an embodiment, the game providing apparatus may determine the auction end time point to be any time point in the auction end time range but may further consider the circumstances associated with the game item to determine the auction end time point. For example, when the number of bids on the game item is zero, the game providing apparatus may determine the auction end time point to be any time point within a second half of the auction end time range. When the number of bids on the game item exceeds a preset threshold number of bids, the game providing apparatus may determine the auction end time point to be any time point within a first half of the auction end time range.

In an embodiment, the game providing apparatus may identify whether the condition for sale registration of the game item is satisfied. The game providing apparatus may identify whether the condition for sale registration of the game item is satisfied based on the auction information or the identified sale registration request for the game item. The condition for sale registration of the game item may include whether the condition for sale registration associated with the user or the condition for sale registration associated with the game item to be auctioned is satisfied.

In an embodiment, the condition for sale registration associated with the user may include at least one of whether a security environment of the game providing apparatus of the user who inputs the sale registration request is established, whether the limit on the number of auctions within a certain period given to each user is exceeded, and whether the user holds goods equal to or greater than a sale registration deposit. The sale registration deposit which has the nature of an auction house usage fee may be deducted when registering the game item for sale. The sale registration deposit may be non-refundable when the sale fails or registration is canceled and may discourage the sale registration. However, since the sale registration deposit is refunded upon a successful sale, the sale registration deposit may encourage registration of only names with high product value. The sale registration deposit may be referred to as a registration deposit.

In an embodiment, the condition for sale registration associated with the game item may include whether the game item is a tradeable item or an auctionable item. When the game item is a nickname of a character, the condition for sale registration associated with the game item to be auctioned may include at least one of whether a certain period has elapsed since the character with the nickname being sold was created, whether a certain period has elapsed after the nickname of the character was changed, and whether a certain period has elapsed since the nickname was purchased when the nickname of the character is resold by auction. However, the condition for sale registration is not limited to the above.

In an embodiment, the game providing apparatus may determine to register the game item for sale based on the identification that the condition for sale registration is satisfied. When the game providing apparatus determines to register the game item for sale, the game providing apparatus may display the game item on the auction house interface. The game providing apparatus may deduct the amount of goods for sale registration of the game item from the amount of goods held by the user when determining to register the game item for sale. When the game item is a nickname of a character, the game providing apparatus may change the nickname of the character registered for sale to a nickname that the character will use after registering the nickname included in the auction information for sale.

In an embodiment, when the auction for the game item is started, a public bid on the game item may be made during the auction duration. The game providing apparatus may obtain a bid request during the auction duration. The game providing apparatus may determine, based on the obtained bid request, to deduct the bid from the amount of goods of the user who bids on the game item as a bid deposit. When the auction end time point has passed, the highest bidder before the auction end time point may be determined as a successful bidder and the game item may be provided to the successful bidder.

In an embodiment, based on the identification that the condition for sale registration is not satisfied, the game providing apparatus may provide information that the game item cannot be registered for sale.

In an embodiment, technical effects, such as preventing server overload, preventing exclusive sale in an in-game auction system, minimizing unnecessary sale registration, and preventing hoarding, may be expected through the condition for sale registration.

FIG. 4 is a diagram of a sale registration interface for sale registration of an auction item, according to an embodiment.

FIG. 4 shows a screen on which the sale registration interface 400 is displayed by the game providing apparatus. Through the sale registration interface 400 of FIG. 4, the game providing apparatus may obtain a sale registration request for the auction for the game item and may obtain auction information associated with the game item.

In an embodiment, the sale registration interface 400 may include at least one of an item information interface 410, a minimum bid interface 420, an auction time interface 430, a nickname change interface 440, a price interface 450, and a sale registration request interface 460. The sale registration interface 400 is not limited to the embodiment of FIG. 4. The sale registration interface 400 may further include components different from the components disclosed in FIG. 4 or may not disclose some components in FIG. 4.

In an embodiment, the item information interface 410 may include an interface for displaying a game item to be auctioned, such as a name, an image, or the like of the game item to be auctioned. The item information interface 410 includes the nickname of the character “Nickname A” as the game item to be auctioned but is not limited thereto. For example, the game item to be auctioned may include an equipment item and a consumption item.

In an embodiment, the minimum bid interface 420 may include an interface for obtaining a minimum amount of goods that the user intends to obtain in exchange for selling the game item. The minimum bid may be limited to an amount equal to or greater than the amount of goods that the user must provide to the game service to sell the game item. For example, when a transaction fee is 3000 and a registration deposit is 2000, the game providing apparatus may receive a value of at least 5000 which is the minimum bid.

In an embodiment, the auction time interface 430 may include an interface for the game providing apparatus to obtain the auction duration for the game item. For example, the game providing apparatus may obtain user input from the user to determine the auction duration to be 24 hours or 48 hours. The auction time interface is not limited to the above and may include an interface capable of obtaining at least one of an auction start time point, an auction end time point, and an auction end time range to obtain auction time information.

In an embodiment, the nickname change interface 440 may include an interface for obtaining a nickname to be used by a character instead of a nickname to be auctioned when the game item is a nickname of the character. For example, the game providing apparatus may obtain “Nickname B” as a nickname to be used instead of “Nickname A” through the nickname change interface 440 included in the sale registration interface 400 for auctioning “Nickname A.”

In an embodiment, the price interface 450 may include an interface that includes information about an amount of goods that a user must pay for a game service to register a game item for sale. For example, the price interface 450 may include information that 1% of the minimum bid must be paid as a registration deposit and 10% of the transaction amount must be paid as a sale commission to the game service so as to register the game item for sale. The price interface 450 may include information that, when the game item is a nickname and a fee must be paid when changing the name of the character in the game, a fee for changing the name of the character must be additionally paid.

In an embodiment, the sale registration request interface 460 may include an interface for obtaining a sale registration request for a game item. For example, the game providing apparatus may obtain the sale registration request through user input, such as touch input, to the sale registration request interface 460. Whether the condition for sale registration is satisfied on the basis of the sale registration request is described in detail with reference to FIG. 3 and the overlapping description is omitted.

In an embodiment, when the game providing apparatus obtains the sale registration request through the sale registration request interface 460, the game providing apparatus may provide precautions associated with the auction for the game item.

For example, the precautions associated with the auction for the game item may include at least one of information that cancellation due to a change of mind is not possible after registering the game item for sale, information that the registration deposit cannot be returned in the event of a failed bid, information that other game items cannot be registered for sale for a certain period depending on the limited number of game items that can be registered for sale at the auction house, and information about the amount of goods deducted when registering the game item for sale.

For example, when the game item is a nickname, the game providing apparatus may provide precautions associated with the auction for the nickname. For example, the precautions associated with the auction for the nickname may include at least one of information that the nickname cannot be restored after the auction is established and that the right to use of the nickname is transferred to a successful bidder, information that the nickname can be restored in case of a failed bid, and information that when the nickname registered for sale at the auction house is confirmed to have a prohibited word, the sale registration may be forcibly canceled. In addition, the precautions associated with the sale of the nickname may include at least one of information that the nickname cannot be changed for a certain period when the nickname is changed through the sale registration of the nickname, information that the nickname cannot be changed to the existing nickname, and information that the nickname cannot be changed to the nickname including a prohibited word.

The precautions associated with the auction for the game item are not limited to the above.

In the disclosure, for convenience of description, the nickname of the character is illustrated as the game item but the disclosure is not limited thereto.

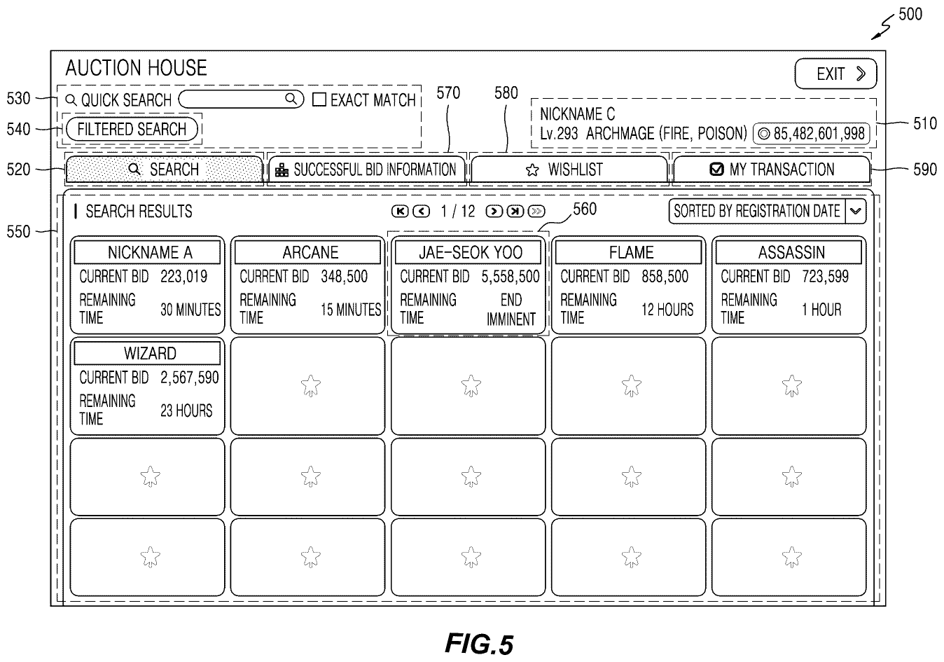

FIG. 5 is a diagram of an auction house interface, according to an embodiment.

FIG. 5 shows a screen on which the auction house interface 500 is displayed by the game providing apparatus. The auction house interface 500 may include an interface displayed by the game providing apparatus when using an auction system provided in the game.

In an embodiment, the auction house interface 500 may include at least one of a user information interface 510, a search interface 520, a search bar interface 530, an item list interface 550, a successful bid information interface 570, a preference interface 580, and a transaction history interface 590. The auction house interface 500 is not limited to the embodiment of FIG. 5. The auction house interface 500 may further include components different from the components disclosed in FIG. 5 or may not disclose some components in FIG. 5.

In an embodiment, the user information interface 510 may include an interface that includes information associated with a user provided with the auction house interface 500. For example, the user information interface 510 may include at least one of a nickname of a character held by the user, a job of the character, a level of the character, and an amount of goods held by the character, but is not limited thereto.

In an embodiment, the search interface 520 may include an interface for obtaining user input to provide information about a game item being auctioned. For example, the game providing apparatus may provide the auction house interface 500 including the item list interface 550 based on the obtained touch input to the search interface 520 from the user. The game providing apparatus may be preset to provide the auction house interface 500 including the item list interface 550 of FIG. 5 without the user input to the search interface 520 when providing the auction house interface 500. However, the search interface 520 is not limited to the above.

In an embodiment, the search bar interface 530 may include an interface for searching for a game item. For example, the search bar interface 530 may include an interface for obtaining a name for an auction item. When the game item to be auctioned is a nickname, the game providing apparatus may search for a nickname including a certain word through the search bar interface 530.

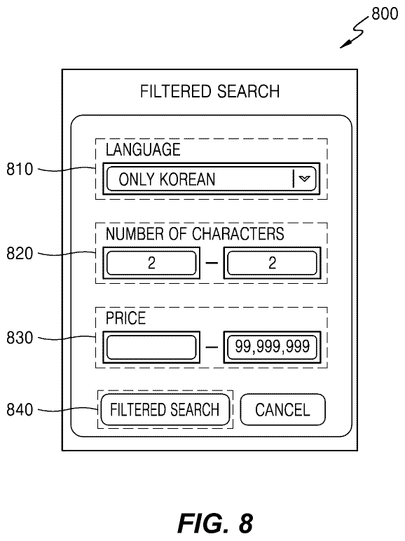

In an embodiment, the search bar interface 530 may include a filtered search interface 540. The filtered search interface 540 may include an interface for displaying a filter interface for filtering and searching the auction item according to detailed conditions. The filter interface displayed through the user input to the filtered search interface 540 may be specifically described with reference to FIG. 8.

In an embodiment, the item list interface 550 may include an interface for displaying a list of at least one item registered for sale at the auction house. In addition, the game providing apparatus may provide the search result, obtained by using the search bar interface 530, through the item list interface 550.

In an embodiment, the item list interface 550 may include a game item interface 560. The game item interface 560 may include an interface for displaying auction progress information associated with one game item. The auction progress information may include at least one of a name of the game item to be auctioned, a highest bid on the game item, and information about a remaining time of the auction for the game item.

In an embodiment, when the imminent auction end time point for the game item has not passed, the game providing apparatus may provide information about the remaining time of the auction for the game item.

In an embodiment, the information about the remaining time may indicate approximate time information from the current time when the game item interface 560 is displayed to the auction end time point. The game providing apparatus may determine the auction end time point to be any time point in the auction end time range. When the imminent auction end time point for the game item has passed, the game providing apparatus may provide information that the auction for the game item may end at any time point through the game item interface 560. For example, the game providing apparatus may provide information that the auction for the game item may end at any time point by indicating “end imminent” in the information about the remaining time.

In an embodiment, the game providing apparatus may obtain information about the preset imminent auction end time point. Alternatively, the game providing apparatus may obtain information about the imminent auction end time point from the user. For example, the game providing apparatus may determine the imminent auction end time point as a starting point of the auction end time range or a time point ahead of the auction end time point. For example, the game providing apparatus may determine the imminent auction end time point as a time point that is five minutes prior to the starting point of the auction end time range. Alternatively, the game providing apparatus may determine the imminent auction end time point as a time point that is ten minutes before the auction duration elapses from the auction start time point. The imminent auction end time point may be determined based on a different time point than the above and is not limited thereto.

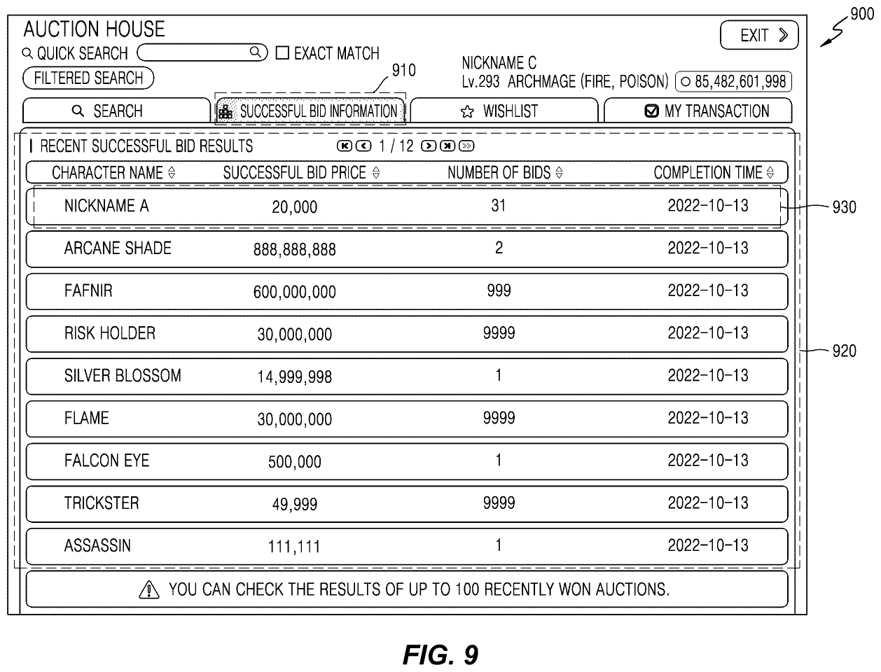

In an embodiment, the successful bid information interface 570 may include an interface for obtaining user input to provide information associated with a recently won game item through the auction house interface 500. For example, the game providing apparatus may provide information associated with the auction for the recently won game item through the auction house interface of FIG. 9 based on the obtained touch input to the successful bid information interface 570 from the user. The item list interface displayed through the user input to the successful bid information interface 570 may be described in detail with reference to FIG. 9.

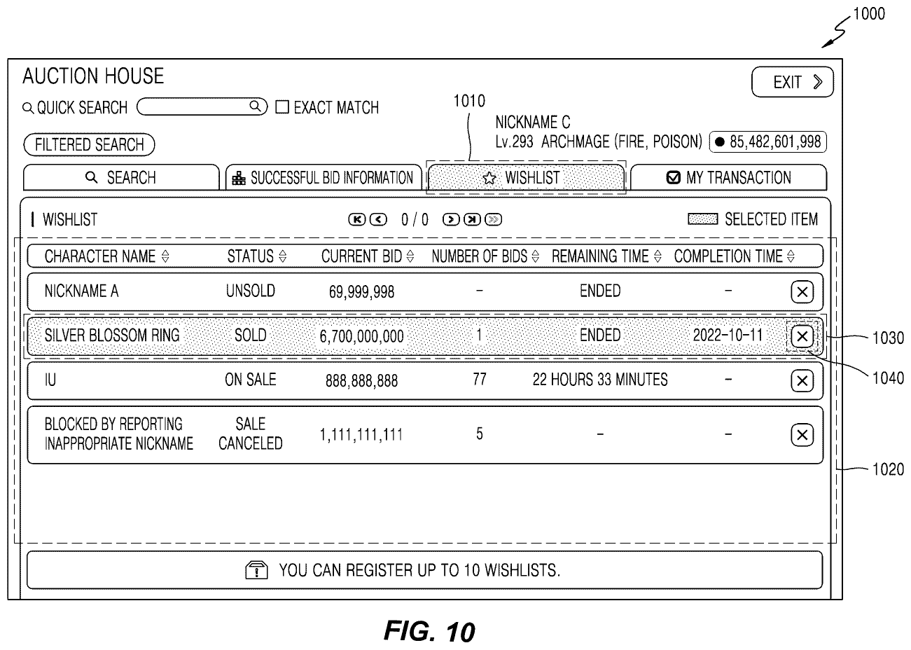

In an embodiment, the preference interface 580 may include an interface for obtaining user input to provide information associated with an auction for a game item preferred by a user provided with the auction house interface 500. For example, the game providing apparatus may provide information associated with the auction for the game item preferred by the user through the auction house interface of FIG. 10 based on the obtained mouse input to the preference interface 580 from the user. The item list interface displayed through the user input to the preference interface 580 may be described in detail with reference to FIG. 10.

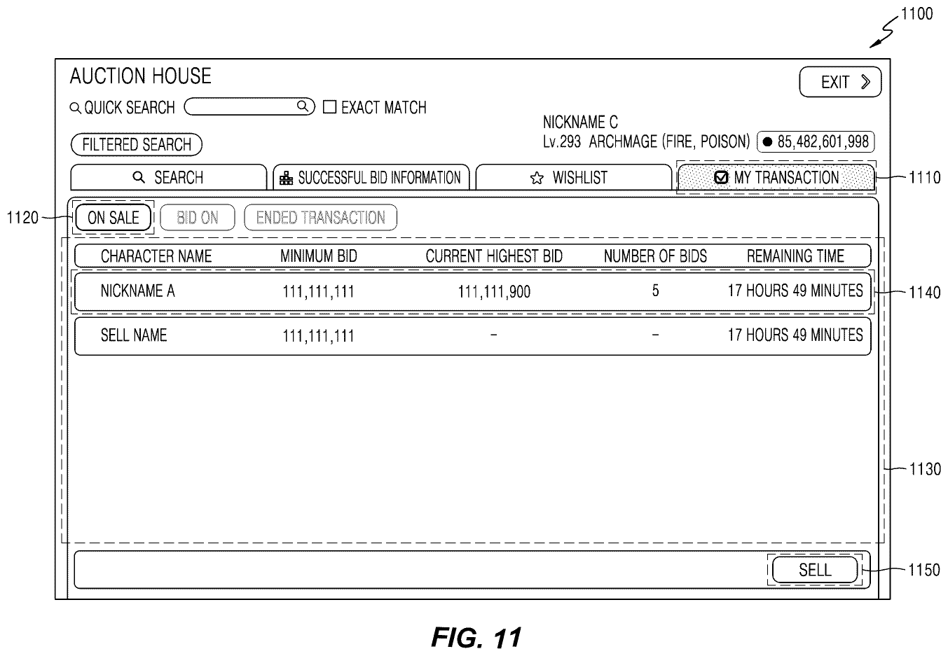

In an embodiment, the transaction history interface 590 may include an interface for obtaining user input to provide information associated with an auction for a game item traded through the in-game auction system. For example, the game providing apparatus may provide information associated with the auction for the game item that the user has traded through the in-game auction system based on the obtained voice input to the transaction history interface 590. The item list interface displayed through the user input to the transaction history interface 590 may be described in detail with reference to FIGS. 11 to 13.

The item list interfaces in FIGS. 5, 9, 10, and 11 to 13 may each display different information.

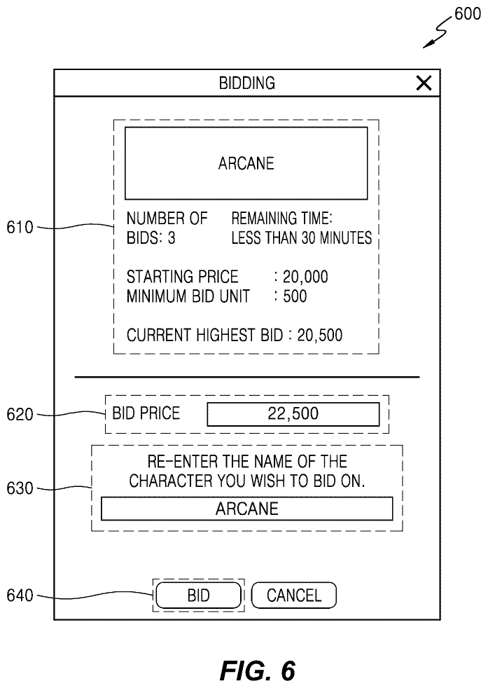

FIG. 6 is a diagram of a bidding interface for bidding on an auction item, according to an embodiment.

FIG. 6 shows a screen in which the bidding interface 600 is displayed by the game providing apparatus. The bidding interface 600 may include an interface displayed by the game providing apparatus when the game providing apparatus obtains user input associated with bidding on a game item.

In an embodiment, the bidding interface 600 may include an interface displayed by the game providing apparatus when the game providing apparatus obtains user input to an interface associated with the game item provided in the auction house interface 500. For example, referring to FIG. 5, the bidding interface 600 may include an interface which is provided by the game providing apparatus in response to obtaining user input to the game item interface that includes a nickname “Arcane” included in the item list interface 550. However, a method by which the game providing apparatus provides the bidding interface 600 is not limited to the above and the bidding interface 600 may be provided when user input for bidding is identified.

In an embodiment, the bidding interface 600 may include at least one of a bid item information interface 610, a bid price interface 620, a bid confirmation interface 630, and a bid request interface 640. The bidding interface 600 is not limited to the embodiment of FIG. 6. The bidding interface 600 may further include components different from the components disclosed in FIG. 6 or may not disclose some components in FIG. 6.

In an embodiment, the bid item information interface 610 may include an interface for displaying information about a game item to be bid. However, a user who has registered the game item for sale to an auction house may be different from a user who intends to bid on the game item.

In an embodiment, the bid item information interface 610 may include information about at least one of a name of the game item, a number of bids, a highest bid, a remaining time of the auction, a minimum bid, and a minimum bid unit. The game providing apparatus may include information that the auction for the game item may end at any time point through the bid item information interface 610 when the imminent auction end time point has passed. However, the bid item information interface 610 is not limited to the above.

In an embodiment, the bid price interface 620 may include an interface for obtaining information about an amount of goods that a user can pay to bid on a game item. For example, the game providing apparatus may obtain information from the user that the user can pay 22500 to bid on the nickname “Arcane.” The game providing apparatus may obtain information including the amount of goods that the user can pay, as described in the bid price interface 620, when the user input to the bid request interface 640 is identified.

In an embodiment, the bid confirmation interface 630 may include an interface that assists a user who bids on a nickname of a character to clearly confirm and purchase the nickname of the character when the game item is the nickname of the character. For example, the game providing apparatus may receive the nickname of the character to be bid from the user through the bid confirmation interface 630. The game providing apparatus may identify whether the input nickname of the character is the same as the nickname of the character to be auctioned. The bid confirmation interface 630 is not limited to the above. The bid confirmation interface 630 may include information that suggests reconfirmation of the nickname of the character to be bid.

In an embodiment, the bid request interface 640 may include an interface for obtaining a bid request for the game item. For example, the game providing apparatus may obtain the bid request through the mouse input to the bid request interface 640.

In an embodiment, the game providing apparatus may identify whether the condition for bidding on the game item is satisfied when the bid request is obtained through the bid request interface 640.

In an embodiment, the condition for bidding on the game item may include at least one of whether a security environment of the game providing apparatus of the user who has requested the bid is established, whether the number of transaction restrictions within a certain period is less than or equal to the limit, and whether the user holds goods higher than the bid price entered by the user. However, the condition for bidding on the game item is not limited to the above.

In an embodiment, the game providing apparatus may provide precautions associated with the bid on the game item when obtaining the bid request through the bid request interface 640. For example, the game providing apparatus may identify whether the condition for bidding on the game item is satisfied based on the obtained bid request and provide precautions associated with the bid on the game item when it is identified that the condition for bidding on the game item is satisfied.

In an embodiment, the precautions associated with the bid on the game item may include information that cancellation due to a change of mind after bidding is not possible, information that rebidding is possible at a higher price before the end of the auction, information that a game item that has been successfully bid on cannot be resold within a certain period. When the game item is a nickname, the game providing apparatus may provide precautions associated with the nickname bid. For example, the precautions associated with the nickname bid may include information that the number of nickname transactions may be limited during a certain period, information that when the nickname is successfully bid on and received, the name of the character can be changed immediately and the existing name of the character can be deleted, and information that the name including prohibited words may be recalled.

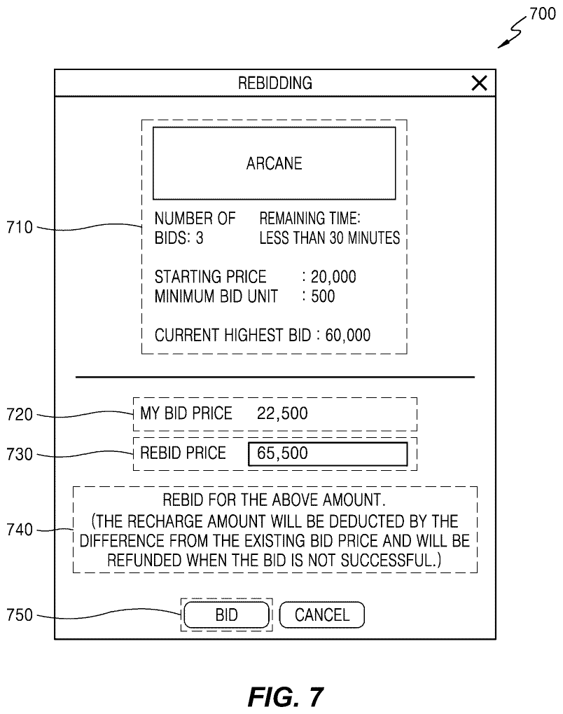

FIG. 7 is a diagram of a rebidding interface for rebidding on an auction item, according to an embodiment.

FIG. 7 shows a screen in which the rebidding interface 700 is displayed by the game providing apparatus. The rebidding interface 700 may include an interface displayed by the game providing apparatus when the game providing apparatus obtains user input for rebidding from a user who has bid on the game item.

In an embodiment, the rebidding interface 700 may include an interface displayed by the game providing apparatus when the game providing apparatus obtains user input to a game item interface provided in the auction house interface 500 from a user who has bid on the game item. For example, referring to FIG. 5, the rebidding interface 700 may include an interface provided by the game providing apparatus in response to obtaining a bid request for the nickname “Arcane” and then obtaining user input again to the game item interface including the nickname “Arcane” included in the item list interface 550. However, a method by which the game providing apparatus provides the rebidding interface 700 is not limited to the above. When the user input for rebidding is identified, the game providing apparatus may provide the rebidding interface 700.

In an embodiment, the rebidding interface 700 may include at least one of a rebid item information interface 710, a previous bid price interface 720, a rebid price interface 730, a rebid confirmation interface 740, and a rebid request interface 750. However, the rebidding interface 700 is not limited to the embodiment of FIG. 7. The rebidding interface 700 may further include components different from the components disclosed in FIG. 7 or may not disclose some components in FIG. 7.

In an embodiment, the rebidding interface 710 may include an interface for displaying information about a game item to be rebid. The rebid item information interface 710 may include information about at least one of a name of the game item to be rebid, a number of bids, a highest bid, a remaining time of the auction, a minimum bid, and a minimum bid unit. The game providing apparatus may include information that the auction for the game item may end at any time point through the rebid item information interface 710 when the imminent auction end time point has passed. However, the rebid item information interface 710 is not limited to the above.

In an embodiment, the previous bid price interface 720 may include an interface for displaying information about the previously bid price. When there are a plurality of bids, the previous bid price interface 720 may display only the most recent bid price or may display all the bid prices.

In an embodiment, the rebid price interface 730 may include an interface for obtaining information about an amount of goods that a user can pay for a game item to be rebid. For example, the game providing apparatus may obtain information from the user that the user can pay 65500 to rebid on the nickname “Arcane”. The game providing apparatus may obtain information including the amount of goods that the user can pay, as described in the rebid price interface 730, when the user input to the rebid request interface 750 is identified.

In an embodiment, the rebid confirmation interface 740 may include an interface for providing information about an amount of goods that are additionally deducted for rebidding on the game item to a user who intends to rebid on the game item. For example, the game providing apparatus may provide information that when the previous bid price for the game item is 22500 and the rebid price is 65500, the goods may be further deducted by 43000 which is the difference between the rebid price and the previous bid price.

In an embodiment, the rebid request interface 750 may include an interface for obtaining a rebid request for a game item. For example, the game providing apparatus may obtain the rebid request through touch input to the rebid request interface 750.

In an embodiment, the game providing apparatus may identify whether the condition for rebidding on the game item is satisfied when the rebid request is obtained through the rebid request interface 750. For example, the condition for the rebidding may include at least one of whether the security environment of the game providing apparatus of the user who requested the rebidding is established, and whether the user holds goods equal to or greater than the difference between the rebid price and the previous bid price. However, the condition for rebidding on the game item is not limited to the above.

In an embodiment, the game providing apparatus may provide precautions associated with the rebid on the game item when obtaining the rebid request through the rebid request interface 750. For example, the game providing apparatus may identify whether the condition for rebidding on the game item is satisfied based on the obtained rebid request and may provide the precautions associated with the rebid on the game item when the condition for rebidding on the game item is identified as being satisfied. The precautions associated with the rebid on the game item may correspond to precautions that are associated with the bid on the game item.

In an embodiment, the game providing apparatus may provide information that an overbid has occurred when another user bids at a higher price on the game item being bid on. The game providing apparatus may obtain a rebid request when another user bids at a higher price on the game item being bid on and may waive the auction and receive a refund of the bid paid. The game providing apparatus may provide information that a bid cancellation request due to a simple change of mind from the user is not possible.

In an embodiment, the game providing apparatus may determine the highest bidder before the auction end time point as the successful bidder when the auction end time point has passed. The game providing apparatus may provide goods to the user who has registered for sale by an amount obtained by deducting the transaction fee from the successful bid and may additionally return and provide the registration deposit. The game providing apparatus may provide the game item to the successful bidder, who is the highest bidder. In addition, as a result of the auction, goods provided to the user who has registered for sale or game items provided to the user who is the successful bidder may expire after a certain period passed from the end of the auction.

FIG. 8 is a diagram of a filter interface for searching for an auction item, according to an embodiment.

FIG. 8 shows a screen in which the filter interface 800 is displayed by the game providing apparatus. The filter interface 800 may include an interface displayed by the game providing apparatus when the game providing apparatus obtains user input to search for a game item registered for sale in the in-game auction system through a detailed filter. For example, the filter interface 800 may include an interface displayed by the game providing apparatus when the game providing apparatus obtains user input to the filtered search interface 540 included in the auction house interface 500.

In an embodiment, the filter interface 800 may include at least one of a language interface 810, a character count interface 820, a price filter interface 830, and a search request interface 840. However, the filter interface 800 is not limited to the embodiment of FIG. 8. The filter interface 800 may further include components different from the components disclosed in FIG. 8 or may not disclose some components in FIG. 8.

In an embodiment, the game providing apparatus may search for a game item by using at least one of a language, a number of characters, and a sale price range. The game item may be searched by using at least one of a language, a number of characters, a sale price range, and a type of the game item.

In an embodiment, the language interface 810 may include an interface for obtaining, from a user who intends to search for a game item, information about a language of the game item to be searched for. For example, when the game item is a nickname of a character, the nickname may be composed only of Korean, only of English, or may include both Korean and English. In this case, the game providing apparatus may obtain information about the language of the nickname of the character through the language interface 810.

In an embodiment, the character count interface 820 may include an interface for obtaining, from a user who intends to search for a game item, information about the number of characters of the game item to be searched for. For example, when the game item is a nickname, the game providing apparatus may obtain user input to search for the game item by limiting the number of characters in the nickname to two to three characters.

In an embodiment, the price filter interface 830 may include an interface for obtaining information about the highest bid at the time of searching for a game item to be searched for. For example, the game providing apparatus may obtain user input to search for the game item of which a highest bid at the time of searching for the game item is 25000 or less.

In an embodiment, the search request interface 840 may include an interface for obtaining a search request for searching for a game item. For example, the game providing apparatus may obtain the bid request through touch input to the search request interface 840.

However, although not disclosed in the filter interface 800, the game providing apparatus may provide results filtered by “equipment item” that is a classification of game items when the equipment item equipped on a character to improve the game item's abilities is searched for.

FIG. 9 is a diagram of an auction house interface, according to an embodiment.

FIG. 9 shows a screen on which the auction house interface 900 is displayed by the game providing apparatus. The auction house interface 900 may include an interface displayed by the game providing apparatus when using the auction system provided in the game.

In an embodiment, the auction house interface 900 may include at least one of a user information interface, a search interface, a search bar interface, a preference interface, a transaction history interface, a successful bid information interface 910, an item list interface 920. The user information interface, the search interface, the search bar interface, the preference interface, the transaction history interface, and the successful bid information interface 910 included in the auction house interface 900 correspond to the user information interface 510, the search interface 520, the search bar interface 530, the preference interface 580, the transaction history interface 590, and the successful bid information interface 570 included in the auction house interface 500 of FIG. 5, respectively, and thus the same description is omitted.

The auction house interface 900 is not limited to the embodiment of FIG. 9. The auction house interface 900 may further include components different from the components disclosed in FIG. 9 or may not disclose some components in FIG. 9.

In an embodiment, the auction house interface 900 may include an interface displayed when user input to the successful bid information interface 910 is obtained. For example, when the game providing apparatus obtains the user input to the successful bid information interface 910, the game providing apparatus may provide the auction house interface 900. The game providing apparatus may be preset to provide the auction house interface 900 including the item list interface 920 of FIG. 9 without the user input to the successful bid information interface 910 when providing the auction house interface 900. However, the successful bid information interface 910 is not limited to the above.

In an embodiment, the item list interface 920 may include an interface for displaying a list of at least one item that has been successfully bid on. The item list interface 920 may include a successful bid item interface 930.

In an embodiment, the successful bid item interface 930 may include an interface for displaying information associated with the successful bid game item when the game item is successfully bid on. For example, the successful bid item interface 930 may include information about at least one of a name of the game item, a successful bid, a total number of bids, and an auction end time point. However, the successful bid item interface 930 is not limited to the above and may include any information associated with the successful bid item.

FIG. 10 is a diagram of an auction house interface, according to an embodiment.

FIG. 10 shows a screen on which the auction house interface 1000 is displayed by the game providing apparatus. The auction house interface 1000 may include an interface displayed by a game providing apparatus when using the auction system provided in the game.

In an embodiment, the auction house interface 1000 may include at least one of a user information interface, a search interface, a search bar interface, a successful bid information interface, a transaction history interface, a preference interface 1010, and an item list interface 1020. The user information interface, the search interface, the search bar interface, the successful bid information interface, the transaction history interface, and the preference interface 1010 included in the auction house interface 1000 correspond to the user information interface 510, the search interface 520, the search bar interface 530, the successful bid information interface 570, the transaction history interface 590, and the preference interface 580 included in the auction house interface 500 of FIG. 5, respectively, and thus the same description is omitted.

The auction house interface 1000 is not limited to the embodiment of FIG. 10. The auction house interface 1000 may further include components different from the components disclosed in FIG. 10 or may not disclose some components in FIG. 10.

In an embodiment, the auction house interface 1000 may include an interface displayed when user input to the preference interface 1010 is obtained. For example, when the game providing apparatus obtains the user input to the preference interface 1010, the game providing apparatus may provide the auction house interface 1000. The game providing apparatus may be preset to provide the auction house interface 1000 including the item list interface 1020 of FIG. 10 without the user input to the preference interface 1010 when providing the auction house interface 1000. However, the preference interface 1010 is not limited to the above.

In an embodiment, the item list interface 1020 may include an interface for displaying a list of at least one item identified as a user's preferred item. The item list interface 1020 may include a preferred item interface 1030.

In an embodiment, the preferred item interface 1030 may include an interface for displaying information associated with a game item preferred by a user when a certain game item is identified as the user's preferred item. For example, the preferred item interface 1030 may include information about at least one of a name of the game item, an auction status for the game item, a highest bid, a total number of bids, a remaining time, and an auction end time point. However, the preferred item interface 1030 is not limited to the above. The preferred item interface 1030 may include any information associated with the game item preferred by the user.

In an embodiment, with respect to the information about the auction status included in the preferred item interface 1030, the game providing apparatus may display “on sale” when the game item is currently being auctioned, display “sold” when the game item has been successfully bid on and the auction has ended, display “unsold” when the game item has not been successfully bid on and the auction has ended, and display “sale canceled” when the nickname is identified as an offensive nickname and the auction is forcibly canceled.

In an embodiment, the information about the remaining time included in the preferred item interface 1030 may include approximate time information from the current time point to the auction end time point for the item currently being auctioned. In addition, the game providing apparatus may provide information that the auction for the game item may end at any time point when the imminent auction end time point has passed.

In an embodiment, the preferred item interface 1030 may include a deletion interface 1040. The deletion interface 1040 may include an interface for obtaining a deletion request to delete a game item included in the item list interface 1020. For example, the game providing apparatus may obtain the deletion request through touch input to the deletion interface 1040.

FIG. 11 is a diagram of an auction house interface, according to an embodiment.

FIG. 11 shows a screen on which the auction house interface 1100 is displayed by the game providing apparatus. The auction house interface 1100 may include an interface displayed by the game providing apparatus when using the auction system provided in the game.

In an embodiment, the auction house interface 1100 may include at least one of a user information interface, a search interface, a search bar interface, a successful bid information interface, a preference interface, a transaction history interface 1110, a sale transaction interface 1120, a bid transaction interface, an ended transaction interface, an item list interface 1130, and a sale request interface 1150. The user information interface, the search interface, the search bar interface, the successful bid information interface, the preference interface, and the transaction history interface 1110 included in the auction house interface 1100 correspond to the user information interface 510, the search interface 520, the search bar interface 530, the successful bid information interface 570, the preference interface 580, and the transaction history interface 590 included in the auction house interface 500 of FIG. 5, respectively, and thus the same description is omitted.

The auction house interface 1100 is not limited to the embodiment of FIG. 11. The auction house interface 1100 may further include components different from the components disclosed in FIG. 11 or may not disclose some components in FIG. 11.

In an embodiment, the auction house interface 1100 may include an interface displayed when user input to the transaction history interface 1110 is obtained. For example, the game providing apparatus may provide the auction house interface 1100 of FIG. 11 when obtaining user input to the transaction history interface 1110. The game providing apparatus may provide information about the game item being sold through the auction house interface 1100 of FIG. 11. The game providing apparatus may be preset to provide the auction house interface 1100 including the item list interface 1130 of FIG. 11 without the user input to the transaction history interface 1110 when providing the auction house interface 1100. However, the transaction history interface 1110 is not limited to the above.

In an embodiment, the sale transaction interface 1120 may include an interface for obtaining user input to provide information about the game item being sold through the auction system. For example, the game providing apparatus may provide information about the game item being sold based on the obtained mouse input to the sale transaction interface 1120 from the user.

In an embodiment, the item list interface 1130 may include an interface for displaying a list of at least one game item being sold through the auction system. The item list interface 1130 may include a sale item interface 1140.

In an embodiment, the sale item interface 1140 may include an interface for displaying information associated with the game item being sold by the user. For example, the sale item interface 1140 may include information about at least one of a name of the game item, a minimum bid, a highest bid, a total number of bids, and a remaining time. However, the sale item interface 1140 is not limited to the above. The sale item interface 1140 may include any information associated with the game item being sold by the user.

In an embodiment, the information about the remaining time included in the sale item interface 1140 corresponds to the information about the remaining time included in the preferred item interface 1030 and thus is omitted.

In an embodiment, the sale request interface 1150 may include an interface for obtaining user input, to sell the game item in the auction system. For example, the game providing apparatus may obtain information about the game item that the user intends to sell in the auction system through touch input to the sale request interface 1150 and may provide the sale registration interface 400 for the item that the user intends to sell in the auction system.

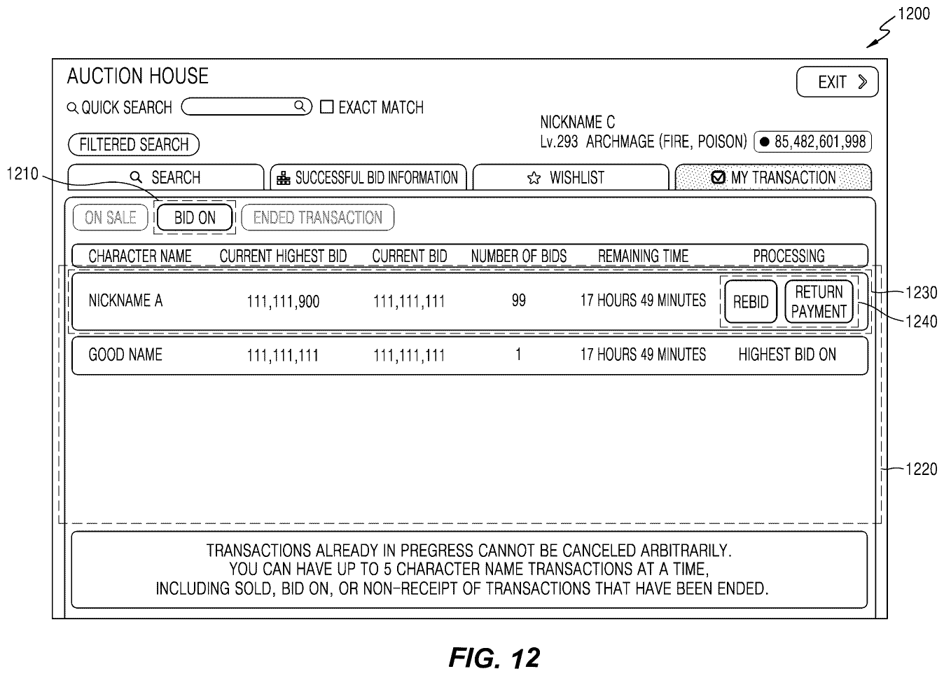

FIG. 12 is a diagram of an auction house interface, according to an embodiment.

FIG. 12 shows a screen on which the auction house interface 1200 is displayed by the game providing apparatus. The auction house interface 1200 may include an interface displayed by the game providing apparatus when using the auction system provided in the game.

In an embodiment, the auction house interface 1200 may include at least one of a user information interface, a search interface, a search bar interface, a successful bid information interface, a preference interface, a transaction history interface, a sale transaction interface, a bid transaction interface 1210, an ended transaction interface, and an item list interface 1220. Overlapping description with reference to FIG. 11 is omitted.

The auction house interface 1200 is not limited to the embodiment of FIG. 12. The auction house interface 1200 may further include components different from the components disclosed in FIG. 12 or may not disclose some components in FIG. 12.

In an embodiment, the bid transaction interface 1210 may include an interface for obtaining user input to provide information about the game item being bid on. For example, the game providing apparatus may provide the auction house interface 1200 of FIG. 12 based on the obtained touch input to the bid transaction interface 1210 from the user. The game providing apparatus may provide information about the game item for which the auction has not ended among game items that have been bid on through the auction house interface 1200. The game providing apparatus may be preset to provide the auction house interface 1200 including the item list interface 1220 of FIG. 12 without user input to the bid transaction interface 1210 when providing the auction house interface 1200. However, the bid transaction interface 1210 is not limited to the above.

In an embodiment, the item list interface 1220 may include an interface for displaying a list of at least one item being bid on by the user. The item list interface 1220 may include a bid item interface 1230.

In an embodiment, the bid item interface 1230 may include an interface for displaying information associated with the game item being bid on. For example, the bid item interface 1230 may include information about at least one of a name of the game item, a highest bid, a bid price of the user who received the auction house interface 1200, a total number of bids, a remaining time, and an additional processing method. However, the bid item interface 1230 is not limited to the above. The bid item interface 1230 may include any information associated with the game item being bid on by the user.

In an embodiment, the information about the remaining time included in the bid item interface 1230 corresponds to the information about the remaining time included in the preferred item interface 1030 in FIG. 10 and thus is omitted.

The additional processing method included in the bid item interface 1230 may be provided through a bid processing interface 1240. The bid processing interface 1240 may provide a processing method associated with the auction to a user (hereinafter, the user) who has received the auction house interface 1200. For example, when the user's bid amount is equal to the highest bid, the game providing apparatus may provide information that the user bid at the highest price. The game providing apparatus may provide the user with an interface for a rebid request or a refund request when the bid amount of the user is different from the highest bid. In addition, the game providing apparatus may obtain the rebid request or the refund request, to provide the rebidding interface 700 or return an amount of goods paid for bidding.

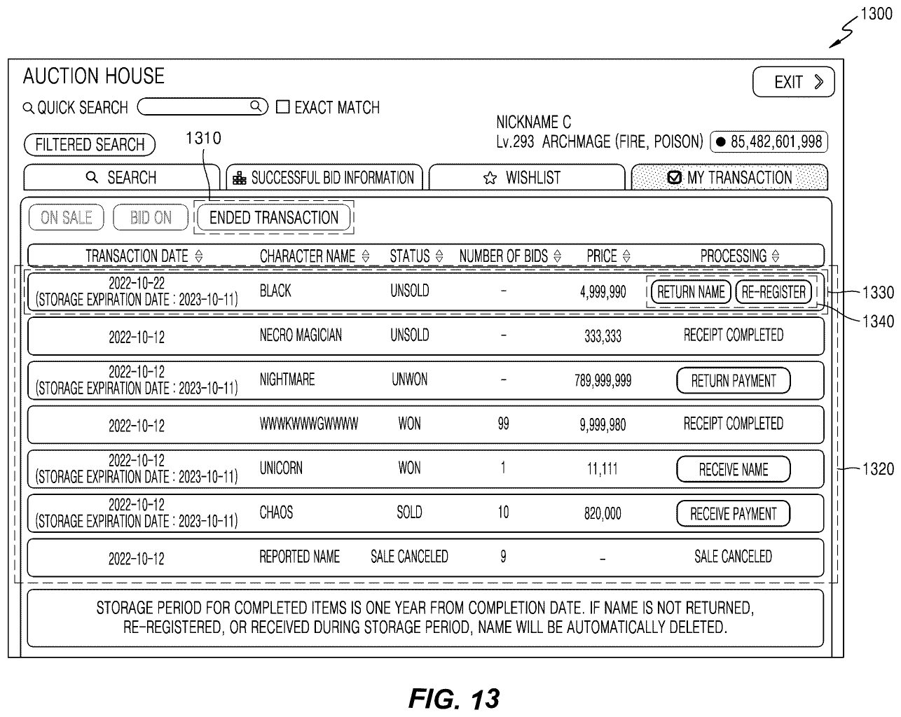

FIG. 13 is a diagram of an auction house interface, according to an embodiment.

FIG. 13 shows a screen on which the auction house interface 1300 is displayed by the game providing apparatus. The auction house interface 1300 may include an interface displayed by the game providing apparatus when using the auction system provided in the game.

In an embodiment, the auction house interface 1300 may include at least one of a user information interface, a search interface, a search bar interface, a successful bid information interface, a preference interface, a transaction history interface, a sale transaction interface, a bid transaction interface, an ended transaction interface1310, and an item list interface 1320. Overlapping description with reference to FIGS. 11 and 12 is omitted.

The auction house interface 1300 is not limited to the embodiment of FIG. 13. The auction house interface 1300 may further include components different from the components disclosed in FIG. 13 or may not disclose some components in FIG. 13.

In an embodiment, the ended transaction interface 1310 may include an interface for obtaining user input to provide information about a game item for which the auction has ended among game items sold or bid on by the user through the auction system. For example, the game providing apparatus may provide the auction house interface 1300 of FIG. 13 based on the obtained touch input to the ended transaction interface 1310. The game providing apparatus may provide information about the game item for which the auction has ended among game items sold or bid on by the user through the auction house interface 1300. The game providing apparatus may be preset to provide the auction house interface 1300 including the item list interface 1320 of FIG. 13 without user input to the ended transaction interface 1310 when providing the auction house interface 1300. However, the ended transaction interface 1310 is not limited to the above.

In an embodiment, the item list interface 1320 may include an interface for displaying a list of at least one game item for which the auction has ended among game items sold or bid on by the user through the auction system. The item list interface 1320 may include an ended item interface 1330.

In an embodiment, the ended item interface 1330 may include an interface for displaying information associated with the game item for which the auction has ended among game items sold or bid on by the user. For example, the ended item interface 1330 may include information about at least one of a name of the game item, a date of the transaction, an auction status, a total number of bids, a highest bid, and an additional processing method. However, the ended item interface 1330 is not limited to the above. The ended item interface 1330 may include any information associated with the game item for which the auction has ended among game items sold or bid on by the user.

In an embodiment, the information about the date of the transaction included in the ended item interface 1330 may include at least one of a date when the auction ended, a date when storage for the successful bid game item expires, and a date when storage for the money for the successful bid game item expires.

In an embodiment, with respect to the information about the auction status included in the ended item interface 1330, the game providing apparatus may display “unsold” when the game item sold by the user has been not successfully bid on and the auction has ended and may display “sold” when the game item sold by the user has been successfully bid on and the auction has ended. In addition, the game providing apparatus may display “unwon” when the user does not win the bid on the game item that the user bid on and may display “won” when the user wins the bid on the game item that the user bid on. In addition, the game providing apparatus may display “sale canceled” when the game item sold or bid on by the user is identified with an inappropriate nickname and the auction is forcibly canceled.

In an embodiment, the game providing apparatus may provide information associated with the additional processing method included in the ended item interface 1330 through the termination processing interface 1340. The termination processing interface 1340 may provide an interface for obtaining a return request or a resale registration request for the game item when the auction status is “unsold.” In addition, the game providing apparatus may obtain the return request or the resale registration request for the game item and determine to return the game item or re-register the game item for sale. When the game item has been returned to the user, the game providing apparatus may display information indicating that the game item has been returned to the user.

In an embodiment, the termination processing interface 1340 may include an interface for a receipt request to obtain goods as compensation for the auction for the game item when the auction status is “sold.” The game providing apparatus may obtain the receipt request and provide certain goods to the user who sold the game item. In addition, when the user acquires the goods, the game providing apparatus may display information that the user has already received the goods.

In an embodiment, the termination processing interface 1340 may include an interface for a return request of goods paid for bidding on the game item when the auction status is “unwon.” The game providing apparatus may obtain the return request and determine to return the bid to the user. In addition, when the game providing apparatus obtains the return request, determines to return the bid to the user, and returns the bid to the user, the game providing apparatus may display information that the user has received the bid.

In an embodiment, the termination processing interface 1340 may include an interface for a receipt request of the game item when the auction status is “won.” The game providing apparatus may obtain the receipt request to provide the game item to the user who successfully bids on the game item. In addition, the game providing apparatus may display information that the user has received the game item when the user who successfully bids on the game item receives the game item.

In an embodiment, the termination processing interface 1340 may provide information that the sale has been canceled when the auction status is “sale canceled.”

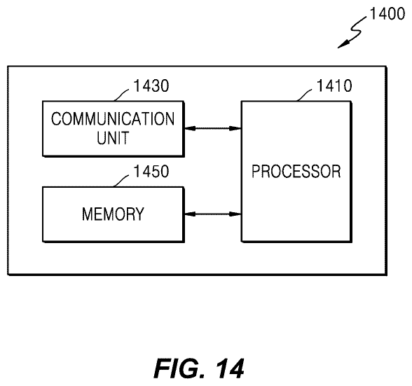

FIG. 14 is a diagram illustrating the detailed configuration of a game providing apparatus, according to an embodiment.

As shown in FIG. 14, a game providing apparatus 1400 according to some embodiments may include at least one processor 1410 (hereinafter referred to as a processor), a communication unit 1430, and memory 1450. However, the components illustrated in FIG. 14 are not all essential components of the game providing apparatus 1400. The game providing apparatus 1400 may be implemented by more components than the components illustrated in FIG. 14 and the game providing apparatus 1400 may be implemented by fewer components than the components illustrated in FIG. 14. The game providing apparatus 1400 may include a user terminal, a server, a game network system, or a separate device.

According to an embodiment, the processor 1410 typically controls the overall operation of the game providing apparatus 1400. For example, the processor 1410 may generally control the communication unit 1430, the memory 1450, and the like by executing programs stored in the memory 1450. The processor 1410 may control the operation of the game providing apparatus 1400 herein by controlling the communication unit 1430, the memory 1450, and the like. The programs stored in the memory 1450 may include instructions for operation of the game providing apparatus.

According to an embodiment, the processor 1410 may obtain auction information associated with the auction for the game item. The auction information may include auction time information associated with a time of the auction. The processor 1410 may obtain, based on the auction time information, an auction end time range indicating a time range in which the auction ends. The processor 1410 may determine the auction end time point for the game item to be any time point in the auction end time range.

According to an embodiment, the processor 1410 may identify whether the condition for registering the game item for sale is satisfied and determine whether to register the game item for sale based on the identification that the condition for registering the game item for sale is satisfied.

According to an embodiment, the processor 1410 may provide information that the auction for the game item may end at any time point when the imminent auction end time point for the game item has passed.

According to an embodiment, the processor 1410 may execute the instructions to provide information that the game item cannot be registered for sale for the auction based on the identification that the condition for registering the game item for sale is not satisfied.

According to an embodiment, the processor 1410 may execute the instructions to provide information about the remaining time of the auction for the game item when the imminent auction end time point for the game item has not passed.

In an embodiment, the communication unit 1430 may perform communication with an external apparatus under the control by the processor 1410. For example, the communication unit 1430 may perform communication with the external apparatus, such as a payment server and an authentication server, under the control by the processor 1410. The communication unit 1430 may also obtain user information or user input through the communication with an external interface.

In an embodiment, the memory 1450 may store programs for processing and controlling the processor 1410 and may also store data input to or output from the game providing apparatus 1400. According to an embodiment, the memory 1450 may store auction information, auction time information, and information associated with the game item according to the disclosure.

According to an embodiment, the processor 1410 may execute the method of providing the game service by using the programs stored in the memory 1450. For example, the processor 1410 may obtain the auction information associated with the auction for the game item based on at least one piece of information stored in the memory 1450, wherein the auction information may include auction time information associated with a time of the auction. The processor 1410 may obtain, based on the at least one piece of information stored in the memory 1450 and the auction time information, an auction end time range indicating a time range in which the auction ends. The processor 1410 may determine the auction end time point for the game item to be any time point in the auction end time range based on the at least one piece of information stored in the memory 1450.

According to an embodiment, the memory 1450 may include at least one type of storage media among a flash memory type, a hard disk type, a multimedia card micro type, card-type memory (e.g., SD or XD memory), random-access memory (RAM), static random-access memory (SRAM), read-only memory (ROM), electrically erasable programmable read-only memory (EEPROM), programmable read-only memory (PROM), magnetic memory, a magnetic disk, and an optical disk. In addition, according to an embodiment, programs stored in the memory 1450 may be classified into a plurality of modules according to their functions.

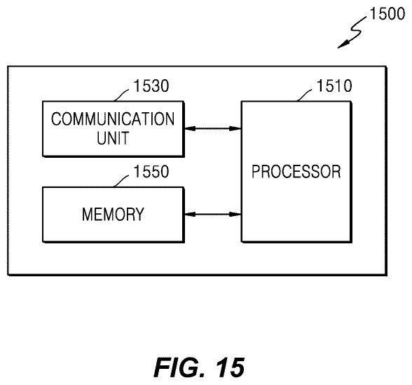

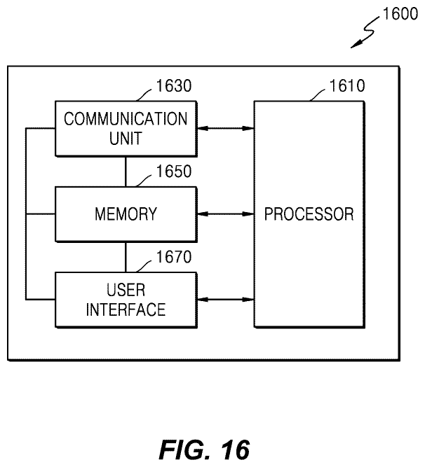

According to an embodiment, the method of providing the game service may be performed by the game providing apparatus 1400 or may also be performed by a server or a user terminal. In addition, at least one component included in the game providing apparatus 1400 may perform the embodiments described above with reference to FIGS. 1 to 13. In addition, the method of providing the game service may be performed by the server and the user terminal separately or together. The configurations of the server and the user terminal are described in more detail below with reference to FIG. 15 and FIG. 16.

FIG. 15 is a diagram illustrating the detailed configuration of a server, according to an embodiment.

As shown in FIG. 15, a server 1500 according to some embodiments may include at least one processor 1510, a communication unit 1530, and memory 1550. However, the components illustrated in FIG. 15 are not all essential components of the server 1500. The server 1500 may be implemented by more components than the components illustrated in FIG. 15 and the server 1500 may be implemented by fewer components than the components illustrated in FIG. 15.

According to an embodiment, the processor 1510 typically controls the overall operation of the server 1500. For example, the processor 1510 may generally control the communication unit 1530, the memory 1550, and the like by executing the programs stored in the memory 1550. The processor 1510 may control the operation of the server 1500 herein by controlling the communication unit 1530, the memory 1550, and the like.

According to an embodiment, the processor 1510 may obtain auction information associated with the auction for the game item. The auction information may include auction time information associated with a time of the auction. The processor 1510 may obtain, based on the auction time information, an auction end time range indicating a time range in which the auction ends. The processor 1510 may determine the auction end time point for the game item to be any point in the auction end time range.

According to an embodiment, the operation of the processor 1510 may correspond to the operation of the processor 1410 of the game providing apparatus 1400 described with reference to FIG. 14 and thus detailed description thereof is omitted.

The communication unit 1530 may provide a query to the user terminal 1600 and receive information about a response to the query under the control by the processor 1510. In addition, according to an embodiment, the communication unit 1530 may transmit and receive data to and from the user terminal 1600, wherein the data transmitted and received to and from the user terminal 1600 may include control data for controlling the user terminal 1600 or programs included in the user terminal 1600.

The memory 1550 may store programs for processing and controlling the processor 1510 and may also store data input to or output from the server 1500. According to an embodiment, the memory 1550 may store at least one piece of information that the memory 1450 of the game providing apparatus 1400 of FIG. 14 can store.

According to an embodiment, the processor 1510 may execute the method of providing the game service by using the programs stored in the memory 1550.

According to an embodiment, the memory 1550 may include at least one type of storage media among a flash memory type, a hard disk type, a multimedia card micro type, card-type memory (e.g., SD or XD memory), RAM, SRAM, ROM, EEPROM, PROM, magnetic memory, a magnetic disk, and an optical disk. In addition, according to an embodiment, the programs stored in the memory 1550 may be classified into a plurality of modules according to their functions.

In addition, according to an embodiment, the method of providing the game service may be performed by each of the server 1500 and the user terminal 1600, may be performed separately by the server 1500 and the user terminal 1600, or may be performed by the game providing apparatus 1400.

FIG. 16 is a diagram illustrating the detailed configuration of a user terminal, according to some embodiments.

As shown in FIG. 16, a user terminal 1600 according to some embodiments may include at least one processor 1610, a communication unit 1630, memory 1650, and a user interface 1670. However, the components illustrated in FIG. 16 are not all essential components of the user terminal 1600. The user terminal 1600 may be implemented by more components than the components illustrated in FIG. 16 and the user terminal 1600 may be implemented by fewer components than the components illustrated in FIG. 16.

According to an embodiment, the processor 1610 typically controls the overall operation of the user terminal 1600. For example, the processor 1610 may generally control the communication unit 1630, the memory 1650, the user interface 1670, and the like by executing programs stored in the memory 1650. The processor 1610 may control the operation of the user terminal 1600 herein by controlling the communication unit 1630, the memory 1650, the user interface 1670, and the like.

According to an embodiment, the processor 1610 may obtain auction information associated with the auction for the game item. The auction information may include auction time information associated with a time of the auction. The processor 1610 may obtain, based on the auction time information, an auction end time range indicating a time range in which the auction ends. The processor 1610 may determine the auction end time point for the game item to be any time point in the auction end time range.

According to an embodiment, the operation of the processor 1610 may correspond to the operation of the processor 1410 of the game providing apparatus 1400 described with reference to FIG. 14 and thus detailed description thereof is omitted.

The communication unit 1630 may provide a query to the server 1500 and receive information about a response to the query under the control by the processor 1610. In addition, according to an embodiment, the communication unit 1630 may transmit and receive data to and from the server 1500, wherein the data transmitted and received to and from the server 1500 may include control data for controlling the user terminal 1600 or programs included in the user terminal 1600.

According to an embodiment, the communication unit 1630 may include, but is not limited to, a Bluetooth communication unit, a Bluetooth low energy (BLE) communication unit, a near field communication unit, a wireless local area network (WLAN) communication unit, a Zigbee communication unit, an infrared data association (IrDA) communication unit, a Wi-Fi direct (WFD) communication unit, an ultra-wideband (UWB) communication unit, an Ant+ communication unit, and the like.

In addition, according to an embodiment, the communication unit 1630 transmits and receives a wireless signal to and from at least one of a base station, an external terminal, and a server on a mobile communication network. The wireless signal may include various types of data based on voice call signals, video call signals, or text/multimedia message transmission and reception.

The memory 1650 may store programs for processing and controlling the processor 1610 and may also store data input to or output from the user terminal 1600. According to an embodiment, the memory 1650 may store game-related information. For example, the memory 1650 may store at least one piece of information that the memory 1450 of the game providing apparatus of FIG. 14 can store.

According to an embodiment, the processor 1610 may execute the method of providing the game service by using the programs stored in the memory 1650.

According to an embodiment, the memory 1650 may include at least one type of storage media among a flash memory type, a hard disk type, a multimedia card micro type, card-type memory (e.g., SD or XD memory), RAM, SRAM, ROM, EEPROM, PROM, magnetic memory, a magnetic disk, and an optical disk. In addition, according to an embodiment, the programs stored in the memory 1650 may be classified into a plurality of modules according to their functions.

According to an embodiment, the user interface 1670 may include various interfaces. For example, the user interface 1670 may include various interfaces, such as a key pad, a dome switch, a voice input interface, a fingerprint input interface, a touch input interface (contact capacitive type, pressure-type resistive type, infrared detection type, surface ultrasonic conduction type, integral tension measurement type, piezo effect type, etc.), a camera, a jog wheel, a jog switch, and the like, wherein various sensors, such as an acceleration sensor, a position sensor, a temperature sensor, a light sensor, and the like, may be interlocked with the user interface 1670. However, the user interface 1670 is not limited to the above.

According to an embodiment, the user interface 1670 may further include an output unit (not shown). The output unit may include at least one of a liquid crystal display, a thin film transistor-liquid crystal display, an organic light-emitting diode, a flexible display, a three-dimensional (3D) display, and an electrophoretic display. When the display and the touchpad have a layered structure to form a touch screen, the display may be used as an input device in addition to an output device. Additionally, the output unit (not shown) may include an LED lamp, a vibration motor, a speaker, a flash, etc., but is not limited to the above.

Additionally, according to an embodiment, the user interface 1670 may output a notification about game information in the form of image, video, sound, vibration, lamp, and the like.

According to an embodiment, the user interface 1670 may include a sale registration interface 400, an item information interface 410, a minimum bid interface 420, an auction time interface 430, a nickname change interface 440, a price interface 450, and a sale registration request interface 460 of FIG. 4.

According to an embodiment, the user interface 1670 may include the auction house interface 500, the user information interface 510, the search interface 520, the search bar interface 530, the filtered search interface 540, the item list interface 550, the game item interface 560, the successful bid information interface 570, the preference interface 580, the transaction history interface 590 of FIG. 5.

According to an embodiment, the user interface 1670 may include the bidding interface 600, the bid item information interface 610, the bid price interface 620, the bid confirmation interface 630, and the bid request interface 640 of FIG. 6.

According to an embodiment, the user interface 1670 may include the rebidding interface 700, the rebid item information interface 710, the previous bid price interface 720, the rebid price interface 730, the rebid confirmation interface 740, and the rebid request interface 750 of FIG. 7.

According to an embodiment, the user interface 1670 may include the filter interface 800, the language interface 810, the character count interface 820, the price filter interface 830, and the search request interface 840 of FIG. 8.

According to an embodiment, the user interface 1670 may include the auction house interface 900, the user information interface, the search interface, the search bar interface, the preference interface, the transaction history interface, the successful bid information interface 910, the item list interface 920, and the successful bid item interface 930 of FIG. 9.

According to an embodiment, the user interface 1670 may include the auction house interface 1000, the user information interface, the search interface, the search bar interface, the successful bid information interface, the transaction history interface, the preference interface 1010, the item list interface 1020, the preferred item interface 1030, and the deletion interface 1040 of FIG. 10.

According to an embodiment, the user interface 1670 may include the auction house interface 1100, the user information interface, the search interface, the search bar interface, the successful bid information interface, the preference interface, the transaction history interface 1110, the sale transaction interface 1120, the bid transaction interface, the ended transaction interface, the item list interface 1130, the sale item interface 1140, and the sale request interface 1150 of FIG. 11.

According to an embodiment, the user interface 1670 may include the auction house interface 1200, the user information interface, the search interface, the search bar interface, the successful bid information interface, the preference interface, the transaction history interface, the sale transaction interface, the bid transaction interface 1210, the ended transaction interface, the item list interface 1220, the bid item interface 1230, and the bid processing interface 1240 of FIG. 12.

According to an embodiment, the user interface 1670 may include the auction house interface 1300, the user information interface, the search interface, the search bar interface, the successful bid information interface, the preference interface, the transaction history interface, the sale transaction interface, the bid transaction interface, the ended transaction interface 1310, the item list interface 1320, and the ended item interface 1330 of FIG. 13.

However, the above interfaces have been described as examples of the user interface 1670, wherein the user interface 1670 of the disclosure may include more diverse interfaces.

The apparatus described above may be implemented with hardware components, software components, and/or a combination of hardware components and software components. For example, the apparatus and components described in embodiments, such as a processor, a controller, an arithmetic logic unit (ALU), a digital signal processor, a microcomputer, a field-programmable gate array (FPGA), a programmable logic unit (PLU), a microprocessor, or any other apparatus capable of executing and responding to instructions, may be implemented by using one or more general-purpose computers or special-purpose computers. A processing device may execute an operating system (OS) and one or more software applications that run on the OS. Additionally, the processing device may access, store, manipulate, process, and generate data in response to the execution of software. For ease of understanding, although in some cases only one processing unit is described as being used, those skilled in the art may understand that the processing device may include multiple processing elements and/or multiple types of processing elements. For example, the processing device may include a plurality of processors or one processor and one controller. Additionally, other processing configurations, such as parallel processors, are possible.

Software may include computer programs, code, instructions, or a combination thereof, and may configure the processing device to operate as desired or may instruct the processing device independently or collectively. To be interpreted by the processing device or to provide instructions or data to the processing device, software and/or data may be embodied permanently or temporarily, in any type of machine, component, physical device, virtual equipment, computer storage medium or device, or transmitted signal wave. Software may be distributed over networked computer systems and stored or executed in a distributed manner. Software and data may be stored in one or more computer-readable recording media.

The method according to an embodiment may be implemented in the form of program instructions that can be executed through various computer means and may be recorded on a computer-readable medium. The computer-readable medium may include program instructions, data files, data structures, etc., solely or in combination. The program instructions recorded on the medium may be specially designed and configured for embodiments or may be known and available to those skilled in the art of computer software. Examples of the computer-readable recording medium include a magnetic medium, such as a hard disk, a floppy disk, and magnetic tape, an optical medium, such as CD-ROM and DVD, a magneto-optical medium, such as a floptical disk, and a specially configured hardware device to store and execute program instructions, such as ROM, RAM, flash memory, and the like. Examples of the program instructions include machine language code, such as code produced by a compiler, as well as high-level language code that can be executed by a computer using an interpreter, etc. The hardware device described above may be configured to operate as one or more software modules to perform the operations of embodiments, and vice versa.

As described above, although some embodiments have been described with limited examples and drawings, various modifications and variations can be made by those skilled in the art from the above description. For example, although the described techniques are performed in a different order than the afore-mentioned method, and/or the components of the described system, structure, device, circuit, and the like are combined by a different method from the afore-mentioned method, or replaced by other components or equivalents, adequate results may be achieved.

Therefore, other implementations, other embodiments, and equivalents of the claims also fall within the scope of the claims described below.

According to an embodiment, by providing a method of conducting an auction in the in-game auction system, sniping of the game item by bidding on the game item just before the end of the auction may be prevented, thereby alleviating the load on the server. In addition, according to an embodiment, users may be encouraged to bid on the game item at an appropriate price with sufficient time before the end of bidding.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of providing a game service by a game providing apparatus, the method comprising:
obtaining auction information associated with an auction for a game item, the auction information including auction time information associated with a time of the auction;
obtaining an auction end time range indicating a time range in which the auction ends based on the auction time information; and
determining an auction end time point for the game item to be any time point within the auction end time range.

2. The method of claim 1, wherein the auction time information comprises at least one of an auction duration for the game item, an auction start time point for the game item, an auction end time range for the game item, and an auction end time point for the game item.

3. The method of claim 1, wherein the game item comprises a nickname of a character.

4. The method of claim 1, further comprising:
identifying whether a condition for registering the game item for sale is satisfied, and
determining the sale registration of the game item based on the identifying that the condition for registering the game item for sale is satisfied.

5. The method of claim 1, further comprising providing information that the auction for the game item may end at any time point when the imminent auction end time point for the game item has passed.

6. The method of claim 4, further comprising providing information that the game item cannot be registered for sale based on the identifying that the condition for registering the game item for sale is not satisfied.

7. The method of claim 1, wherein the auction information comprises at least one of a name of the game item, a type of the game item, a number of game items, a minimum bid, and a maximum bid.

8. The method of claim 4, wherein the condition for registering the game item for sale comprises at least one of whether a limit on the number of auctions within a certain period granted to each user is exceeded, whether a user holds goods exceeding a sale registration deposit, and whether the game item is a tradable item or an auctionable item.

9. The method of claim 3, wherein the auction information comprises a nickname to be used by a character after registering the nickname for sale.

10. The method of claim 3, wherein the game item is searchable by using at least one of a language, a number of characters, and a sale price range.

11. The method of claim 1, further comprising providing information about a remaining time of the auction for the game item when the imminent auction end time point for the game item has not passed.

12. A game providing apparatus comprising:
memory configured to store instructions; and
at least one processor functionally connected to the memory and configured to execute the instructions, wherein the at least one processor is further configured to execute the instructions to:
obtain auction information associated with an auction for a game item, wherein the auction information comprises auction time information associated with a time of the auction;
obtain an auction end time range indicating a time range in which the auction ends based on the auction time information; and
determine an auction end time point for the game item to be any time point within the auction end time range.

13. The game providing apparatus of claim 12, wherein the auction time information comprises at least one of an auction duration for the game item, an auction end time point for the game item, an auction start time point for the game item, and an auction end time range for the game item.

14. The game providing apparatus of claim 12, wherein the game item comprises a nickname of a character.

15. The game providing apparatus of claim 12, wherein the at least one processor is further configured to execute the instructions to identify whether a condition for registering the game item for sale is satisfied, and determine the sale registration of the game item based on the identifying that the condition for registering the game item for sale is satisfied.

16. The game providing apparatus of claim 12, wherein the at least one processor is further configured to execute the instructions to provide information that the auction for the game item may end at any time point when the imminent auction end time point for the game item has passed.

17. The game providing apparatus of claim 15, wherein the at least one processor is further configured to execute the instructions to provide information that the game item cannot be registered for sale based on the identifying that the condition for registering the game item for sale is not satisfied.

18. The game providing apparatus of claim 12, wherein the auction information comprises at least one of a name of the game item, a type of the game item, a number of game items, a minimum bid, and a maximum bid.

19. The game providing apparatus of claim 15, wherein the condition for registering the game item for sale comprises at least one of whether a limit on the number of auctions within a certain period granted to each user is exceeded, whether a user holds goods exceeding a sale registration deposit, and whether the game item is a tradable item or an auctionable item.

20. The game providing apparatus of claim 14, wherein the auction information comprises a nickname to be used by a character after registering the nickname for sale.

21. The game providing apparatus of claim 14, wherein the game item is searchable by using at least one of a language, a number of characters, and a sale price range.

22. The game providing apparatus of claim 12, wherein the at least one processor is further configured to execute the instructions to provide information about a remaining time of the auction for the game item when the imminent auction end time point for the game item has not passed.

23. A server comprising: memory configured to store instructions; and at least one processor functionally connected to the memory and configured to execute the instructions, wherein the at least one processor is further configured to execute the instructions to:
obtain auction information associated with an auction for a game item, wherein the auction information comprises auction time information associated with a time of the auction;
obtain an auction end time range indicating a time range in which the auction ends based on the auction time information; and
determine an auction end time point for the game item to be any time point within the auction end time range.

24. A user terminal comprising: memory configured to store instructions; and at least one processor functionally connected to the memory and configured to execute the instructions, wherein the at least one processor is further configured to execute the instructions to:
obtain auction information associated with an auction for a game item, wherein the auction information comprises auction time information associated with a time of the auction;
obtain an auction end time range indicating a time range in which the auction ends based on the auction time information; and
determine an auction end time point for the game item to be any time point within the auction end time range.

25. A non-transitory computer-readable recording medium comprising a program for executing on a computer the method of providing the game service according to claim 1.
